(19) United States
(12) Patent Application Publication
(10) Pub. No.: US 2014/0279259 A1
(43) Pub. Date: Sep. 18, 2014

(54) METHOD AND APPARATUS FOR CONNECTING VENDORS WITH CUSTOMERS THROUGH A VIRTUAL INTERFACE

(71) Applicant: EMERALD GAMES MARKETING LIMITED, DUBLIN 2 (IE)

(72) Inventors: Charles L. Harman, Abbottstown, PA (US); Gerard Christopher Klug, Gibsonia, PA (US)

(73) Assignee: EMERALD GAMES MARKETING LIMITED, DUBLIN 2 (IE)

(21) Appl. No.: 14/139,606

(22) Filed: Dec. 23, 2013

Related U.S. Application Data
(60) Provisional application No. 61/789,940, filed on Mar. 15, 2013.

(51) Int. Cl. G06Q 30/06

(52) U.S. Cl. CPC G06Q 30/0625
USPC 705/26.62

(57) ABSTRACT

The disclosed embodiments relate to connecting real-world vendors with customers through a virtual interface using a computer-implemented method executed by one or more computing devices, an apparatus comprising one or more processors and one or more memories operatively coupled to at least one of the one or more processors, and at least one non-transitory computer-readable medium storing computer-readable instructions. An exemplary method comprises receiving, through a virtual interface, information from a user regarding a desired product or service, providing, through the virtual interface, information to the user regarding one or more real-world vendors offering the desired product or service, and enabling interactions between the user and at least one of the one or more vendors offering the desired product or service through the virtual interface.

### RELATED CASE INFORMATION

This application is a non-provisional of, and claims priority to, U.S. Provisional Patent Application No. 61/789,940, filed Mar. 15, 2013, the disclosure of which is incorporated by reference in its entirety.

### FIELD OF THE INVENTION

The invention relates to a method and apparatus for connecting vendors with customers through a virtual interface.

### SUMMARY OF THE INVENTION

As described herein, the disclosed embodiment relates to a computer-implemented method executed by one or more computing devices for connecting real-world vendors with customers through a virtual interface. An exemplary method comprises receiving, by at least one of the one or more computer devices, through a virtual interface, information from a user regarding a desired product or service, providing, by at least one of the one or more computer devices, through the virtual interface, information to the user regarding one or more real-world vendors offering the desired product or service, and enabling, by at least one of the one or more computer devices, interactions between the user and at least one of the one or more vendors offering the desired product or service through the virtual interface.

The disclosed embodiment further relates to an apparatus for connecting real-world vendors with customers through a virtual interface. An exemplary apparatus comprises one or more processors and one or more memories operatively coupled to at least one of the one or more processors and having instructions stored thereon that, when executed by at least one of the one or more processors, cause at least one of the one or more processors to receive, through a virtual interface, information from a user regarding a desired product or service, provide, through the virtual interface, information to the user regarding one or more real-world vendors offering the desired product or service, and enable, interactions between the user and at least one of the one or more vendors offering the desired product or service through the virtual interface.

The disclosed embodiment also relates to at least one non-transitory computer-readable medium storing computer-readable instructions that, when executed by one or more computing devices, cause at least one of the one or more computing devices to receive, through a virtual interface, information from a user regarding a desired product or service, provide, through the virtual interface, information to the user regarding one or more real-world vendors offering the desired product or service, and enable interactions between the user and at least one of the one or more vendors offering the desired product or service through the virtual interface.

### BRIEF DESCRIPTION OF THE DRAWINGS

FIG. 1 illustrates exemplary categories according to the disclosed embodiment.

FIG. 2 illustrates an exemplary discount schedule according to the disclosed embodiment.

FIG. 3 illustrates an exemplary prize voucher according to the disclosed embodiment.

FIG. 4 illustrates an exemplary customer loop and revenue trail showing interactions between a user and vendors using the platform of the disclosed embodiment.

FIG. 5 shows an exemplary flow of interactions between a user and vendors using the platform of the disclosed embodiment.

FIG. 6 illustrates an exemplary local vendor directory display sample according to the disclosed embodiment.

FIG. 7 illustrates an exemplary redemption page according to the disclosed embodiment.

FIG. 8 illustrates an exemplary Redemption Success Pop-up page according to the disclosed embodiment.

FIG. 9 illustrates an exemplary analytics page according to the disclosed embodiment.

FIG. 10 illustrates an exemplary products and services page according to the disclosed embodiment.

FIG. 11 illustrates an exemplary business presentation interface according to the disclosed embodiment.

FIG. 12 illustrates an exemplary basic information interface according to the disclosed embodiment.

FIG. 13 illustrates an exemplary item tags interface according to the disclosed embodiment.

FIG. 14 illustrates an exemplary two-dimensional (SD) representation interface according to the disclosed embodiment.

FIG. 15 illustrates an exemplary computing device according to the disclosed embodiment.

### DETAILED DESCRIPTION

The disclosed embodiment relates to methods, apparatus, and computer-readable media for connecting real-world vendors with customers through a virtual interface. In particular, the disclosed embodiment relates to helping connect vendors and advertisers with potential customers through a virtual interface on a computing device. More specifically, the disclosed embodiment enables the identification and congregation of a community of users (i.e. customers, buyers, etc.) through virtual gameplay and digital interfacing activities, and facilitates the connection of the community of users with real world servicing vendors through virtual world interactions, thereby creating a unique and customized platform connecting and integrating digital commerce with real-world commerce. According to the disclosed embodiment, any buying community can be connected with relevant vendors and service providers.

More specifically, the disclosed embodiment preferably connects users with local vendors and advertisers using an application platform, such as a gaming platform, running on a computing device. The platform of the disclosed embodiment may be deployed using any known technique, such as a web-based application, a mobile app, software installed locally on a computing device, and the like.

The platform preferably takes the form of an online social game centered on the fantasy play of planning for, and carrying out, a life event, for example, a wedding, buying a house, having a baby, exterior designing and/or landscaping a home, vacationing/hospitality usage events, and the like.

One aspect of the disclosed embodiment is to efficiently and reliably source and select products and services using the platform that enable the user to plan for, and carry out, the life event in the real world. This disclosed embodiment provides real world vendors, preferably geographically local to the user, the opportunity to display their company and a small selection of their products and services to the user via the game platform for use in this fantasy play. Local vendors can be identified based on a variety of criteria, for example, a GPS function on a user's mobile device, the user's address or zip code, and the like.

According to the disclosed embodiment, a user can provide information regarding their need for one or more products and/or services, and the methods of the disclosed embodiment can provide the user with one or more potential vendors or advertisements relevant to the user's needs. The vendors and advertisers are preferably associated with one or more categories of products or services to more efficiently identify their relevancy to the user's needs.

For example, if a user is planning a wedding, their needs might include a wedding dress, a caterer, a florist, a wedding cake, and the like. When the user specifies their needs, vendors and/or advertisers are presented that are relevant to those needs. FIG. 1 illustrates exemplary categories for the above wedding example.

After being identified as being relevant to the user's needs, the user may interact with any of the identified vendors or advertisers. Categories may be condensed into smaller group marques to provide a user or player with an easier choice pattern to select items and local vendors to interact with within the platform. For example, in the wedding example above, MC services, DJ's, bands, soloist, duos, trios and quartets may be place in a gameplay marque “entertainment.” By interacting with vendors and/or advertisers through the platform according to the disclosed embodiment, users may take advantage of offers or discounts offered by the vendors and advertisers.

The methods of the disclosed embodiments can also utilize predictive analytics to collect data about the users or players, and provide vendors and advertisers with trends associated with the users. This information can enable the vendors and advertisers to adjust their products and/or services, as needed.

In addition, through the use of the methods disclosed herein, users can earn rewards associated with products and/or services offered by the identified vendors and advertisers. For example, a player can earn discounts based on their advancement within the platform. According to this example, once the player is identified to a vendor or advertiser (i.e. via swiping a QR bar code displayed at an in-game local vendor's place of business, etc.), discounts earned by playing the game, achieving a certain level of play, or otherwise interacting with the vendor or advertiser through the platform, may be redeemed at the vendor's place of business. The discount schedule preferably has a secure Local Vendor interface and may be changed by the Local Vendor at any time. FIG. 2 illustrates an exemplary discount schedule.

In addition, prize vouchers, or other offers, may be given away through the platform to one or more users from time to time. For example, on a quarterly basis, the platform may award a give-a-way to players valuing as much as $250,000 in one or more prizes. These prizes can be distributed in the form of vouchers redeemable with participating vendors and advertisers for the full face value of the voucher. According to one aspect of the disclosed embodiment, the vendors may be reimbursed a percentage of the voucher value. FIG. 3 illustrates an exemplary prize voucher.

In addition, according to the disclosed embodiment, and as shown in the FIG. 4, the platform of the disclosed embodiment may be implemented via a web-based application, for example, via a social media site, such as Facebook. FIG. 4 illustrates an exemplary customer loop and revenue trail showing interactions between a user and vendors using the platform of the disclosed embodiment.

The platform of the disclosed embodiment may also be implemented via a mobile application as shown in FIG. 5. FIG. 5 shows an exemplary flow of interactions between a user and vendors using the platform of the disclosed embodiment.

While the above diagrams illustrate the use of the platform via a web-browser and mobile application, the platform may be implemented and accessed through any suitable interface on any computing device. In addition, users may earn rewards as described above while using one version of the platform of the disclosed embodiment and redeem them in another, and vice versa. The interfaces through which the user accesses the platform are preferably substantively interchangeable, and a user is not limited to using the methods of the disclosed embodiment through a single interface.

While the above describes exemplary platforms of the disclosed embodiment from the perspective of a user or player, the platforms of the disclosed embodiment are also utilized extensively by vendors and advertisers. Specifically, in order to provide a robust offering of vendors and advertisers to users, the platforms of the disclosed embodiment preferably include a large number of vendors and advertisers.

For this reason, as aspect of the disclosed embodiment relates to establishing relationships with vendors and advertisers to associate their goods and services with the platforms described herein. For example, if a vendor wishes to have his products shown to users via an interface on the disclosed platforms, the vendor may be required to register with the systems of the disclosed embodiment, and pay a fee for the service provided, for example, a subscription fee (i.e. on a monthly basis). Each vendor may also be required to subscribe for a predetermined period of time (i.e. one year, two years, etc.). While subscribed to the services of the platforms of the disclosed embodiment, each vendor will preferably participate in the user features described above, including, for example, the prize voucher redemption feature and the 2) achieved level discount schedule.

After subscribing or otherwise establishing placement with the platforms of the disclosed embodiment, vendors will preferably be provided with one or more displays on the platform, as shown in the diagram below, with reference to the wedding example. These features provide substantial exposure of the vendor to users that are using the platform of the disclosed embodiment, and drive users to those vendors. FIG. 6 illustrates an exemplary local vendor directory display sample.

Features of the disclosed embodiment as they relate to vendors and advertisers are described in detail below.

From the vendor perspective, the platforms of the disclosed embodiments allow vendors the ability to manage their accounts associated with the platforms as well as process game-related functionality, such as Reward Points and Vouchers. Exemplary platforms preferably include browser-based user interfaces to assist Vendors with the following:
Reward Point and Voucher Code Redemption
Analytics Viewer
Offering Overview
Reward Point Trade-in Scheduling
Asset Upload Assistant
In-Game Business Presentation

Redemption Page and Redemption Success

The platforms of the disclosed embodiments also preferably include a Redemption Page for vendor use, which is an interface in which Vendors can validate and redeem various codes provided by customers. FIG. 7 illustrates an exemplary redemption page. If redemption is successful, a redemption success confirmation may be displayed. FIG. 8 illustrates an exemplary Redemption Success Pop-up page.

Referring to the above diagrams, the screen generally includes a Page Title (“Redeem Vouchers and Reward Points”), a Redemption Code Entry, and a “Redemption Code” label, which may include a code entry text field and a “Submit” button. After entering a code, the vendor user may press “Enter” while the entry field has focus or press the “Submit” button to validate the entered code. While the webpage is awaiting a response from the server, the “activity” image becomes visible and animates to show that the system is working. This is preferably merely a validity check and does not “consume” the code.

Upon server response, the “activity” image disappears, and the validity of the code is noted to the user. If the code is valid, the “Redemption Details” panel appears beneath the validity message. In this scenario, the panel preferably displays the date of redemption, a table displaying the voucher value or rewards points discount offer, text informing the Vendor that they have not redeemed the code yet and that they must press “Redeem” as acknowledgement of code use, a “Redeem” button, and “Cancel” button. Of course any other suitable information may also be displayed.

If the user presses the “Redeem” button, all buttons on the Redemption page preferably become disabled, a “Processing” pop-up preferably appears indicating that the code is being redeemed, and upon successful redemption, a “Success” pop-up preferably appears showing, for example, the redeemed code, the vendor ID, the user ID, a transaction confirmation code, and the like. In addition to the in-game events, notifications can be sent to the inboxes of users associated with the user account, users associated with the vendor ID, including, for example, Managers and Administrators.

Analytics Page

The platforms of the disclosed embodiments also preferably include an analytics page that presents a vendor user with a set of data related to their account. FIG. 9 illustrates an exemplary analytics page. The types of data that may be displayed here include, for example:
Impressions (total, monthly average, last 30 days, delta from average). This can include, for example, offering views, offering inspections, vendor inspections, and the like.
Dreambook Inclusions (total, monthly average, last 30 days, delta from average). This can include, for example, information regarding customer selections (i.e. Dreambook inclusions), proposals associated with customer selections (i.e. Dreambook proposals), items commented, and the like. The term “Dreambook” generally refers to a listing of gallery of choices presented to users and the corresponding selections made by those users.
Redemptions & Codes. This can include, for example, reward points (i.e. player spent, redeemed, outstanding, etc.), reward point codes (i.e. generated, redeemed, outstanding, etc.), and the like.

Products & Services

The platforms of the disclosed embodiments also preferably include a products and services interface in which vendors can add and modify information about their business including, for example, upload their business image (logo, storefront, etc.), enter/edit their business description as it appears to players in game, upload their product images, enter/edit their product descriptions and pricing information, tag their products (step-by-step process using predefined tags), set/qualify their Rewards Point discounts, and the like. FIG. 10 illustrates an exemplary products and services page.

On the products and services page, thumbnail images may be displayed to give the Vendor a quick overview of their currently presented offerings. Any active offering can be shown by their image thumbnail; empty offering slots can be shown with a question mark. Clicking an active slot preferably jumps the vendor user to the page bookmark below that details the item offering, and clicking an empty slot preferably starts the New Item Entry process. A business view frame preferably includes any uploaded business images and related descriptions. Business name and location can be drawn from the business database. Links in the section title bar provide navigation, as needed.

The Rewards Points Offers List portion of the products and services page preferably allows users to view and edit their Rewards Points Offers. Features of this portion of the page include, for example, offer slots equal to the number of entries in the schedule, with the offer slots being collapsed by default. The collapsed slot view indicates, for example, point value, text description of the offer as it is presented to players (user editable fields are shown in bold, for example), and the like. Expanding an offer slot preferably shows discounts (i.e. a percentage of price), minimum purchase levels (i.e. value, default currency, etc.), qualifiers (i.e. character-limited, obscenity-filtered text field that permits the user to set qualifiers on their discount offer), characters remaining labels, reserved error message spaces, an update button (i.e. disabled until one or more of the fields is edited), a cancel button (i.e. discards any changes and collapses the slot), and the like. Of course, these features are not all required, and additional features may be included.

The Active Offer Display portion of the products and services page preferably gives a summary view of the item as entered by the vendor. The section title may display the name of the item, any product code, the price, and the like. In the event that the price is not set in US Dollars, an approximated conversion may be presented to inform the Vendor of what the cost of the item will be for gameplay purposes. Links in the section title bar preferably provide navigation including, for example, edit (i.e. opens the New Item interface with the fields pre-filled with existing content), top (i.e. returns the user to the top of the screen), and the like.

The Empty Offer Display portion of the products and services page preferably reminds the vendor user of empty offer slots, and provides a section bar for the slot though no summary content is available to be provided. The section title may display “Available!”, for example, in red. Links in the section title bar provide navigation including, for example, add (i.e. opens the New Item interface), top (returns the user to the top of the screen), and the like.

Business Presentation

In addition, the disclosed embodiment preferably includes a business presentation interface. FIG. 11 illustrates an exemplary business presentation interface. The business presentation interface preferably includes a Business Description, which may provide a textual explanation why the user is being requested to enter a business description, an obscenity-filtered, character limited description field for text entry, and the like. The business presentation interface may also include an image, such as a thumbnail to show the current image, if any, an update Image button that allows the user to browse their computer for an image, an Image Guidelines Info Box (i.e. provides bullet-point data regarding requirements and use of the image) and the like. The business presentation interface may further include a error messaging area, page buttons (i.e. Cancel, which discards any changes during the item edit session and returns to the Offering Overview, Next, which validates submitted data and proceeds, if possible, etc.), and the like. In the event of an error, the appropriate location(s) can be designated with an icon and error text. The screen preferably focuses view on the top-most error first.

Basic Information

FIG. 12 illustrates an exemplary basic information interface. The Basic Product Information interface preferably provides obscenity-filtered fields for information entry, including, for example, Name, Product code, Price, Value, Currency, Estimated prices in other currencies, a Description, an Image (i.e. a thumbnail to show the current image, if any), an update Image button that allows the user to browse their computer for an image, an Image Guidelines Info Box (i.e. provides bullet-point data regarding requirements and use of the image), an Error messaging area, Page Buttons (i.e. cancel, which discards any changes during the item edit session and returns to the Offering Overview, next, which validates submitted data and proceeds, if possible, etc.), and the like. In the event of an error, the appropriate location(s) is/are designated with an icon and error text. The screen preferably focuses the view on the top-most error first.

Item Tags

FIG. 13 illustrates an exemplary item tags interface. The item tags interface preferably includes, for example, an Image Display, which is optimally positioned at the top of the screen regardless of scrolling done in the browser, Item Tags, which allow users to select categories, thereby populating the page with the appropriate tag list, and a number of fields for the Vendor to tag the item. Any field that has not been set may be marked, for example, with a yellow “caution” icon. Item tags may be different for each offering category and will change based on the category selected. This interface may also include Page Buttons (i.e. Cancel, which discards any changes during the item edit session and returns to the Offering Overview, Next, which validates submitted data and proceeds, if possible, etc.), and the like. In the event of an error, the appropriate location(s) can be designated with an icon and error text. The screen preferably focuses the view on the top-most error first. For fields that may be left empty, such as checkbox lists, a pop-up may be used to confirm that the user really wants to proceed without filling in those fields.

2D Representation

FIG. 14 illustrates an exemplary two-dimensional (SD) representation interface. The 2D representation interface enables a vendor to select a representational art asset, which may be used to represent actual asset images in product ‘photos’. The view is preferably similar to the data presented in the Active Offering Slot. Pending aesthetic review, it is possible that these two could be merged into a single panel for use in both locations. A 2D List Header can be used to inform the user that the default display is filtered based on the provided criteria to make the selection process easier. Links can also be used to allow the user to switch between filtered (“filtered”) and unfiltered (“show all”). This interface also preferably includes a List that is populated with 2D items that the developers have tagged similarly to the tags noted by the vendor for the item in question. This interface may also include Page Buttons, such as cancel, which discards any changes during the item edit session and returns to the Offering Overview, next, which validates submitted data and proceeds, if possible, etc. In the event that an item is not selected and the Next button is pressed, the List Header is preferably updated to display “Please Select a 2D Representation” in red. Successfully clicking Next may return the user to the Offerings Overview page.

Computer Implementation

The methods of the disclosed embodiment are preferably computer-implemented and executed by one or more computing devices. In addition, the disclosed embodiment relates to apparatus comprising one or more processors and one or more memories operatively coupled to at least one of the one or more processors. The memories of an exemplary apparatus have instructions stored thereon that, when executed by at least one of the one or more processors, cause at least one of the one or more processors to carry out the steps of the exemplary methods. The disclosed embodiment further relates to non-transitory computer-readable media storing computer-readable instructions that, when executed by at least one of one or more computing devices, cause at least one of the one or more computing devices to carry out the steps of the exemplary methods.

The embodiments described herein may be implemented with any suitable hardware and/or software configuration, including, for example, modules executed on computing devices such as computing device 1510 of FIG. 15. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 1510 has one or more processing device 1511 designed to process instructions, for example computer readable instructions (i.e., code) stored on a storage device 1513. By processing instructions, processing device 1511 may perform the steps set forth in the methods described herein. Storage device 1513 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 1510 additionally has memory 1512, an input controller 1516, and an output controller 1515. A bus 1514 operatively couples components of computing device 1510, including processor 1511, memory 1512, storage device 1513, input controller 1516, output controller 1515, and any other devices (e.g., network controllers, sound controllers, etc.). Output controller 1515 may be operatively coupled (e.g., via a wired or wireless connection) to a display device 1520 (e.g., a monitor, television, mobile device screen, touch-display, etc.) In such a fashion that output controller 1515 can transform the display on display device 1520 (e.g., in response to modules executed). Input controller 1516 may be operatively coupled (e.g., via a wired or wireless connection) to input device 1530 (e.g., mouse, keyboard, touch-pad, scroll-ball, touch-display, etc.) In such a fashion that input can be received from a user (e.g., a user may input with an input device 1530 a dig ticket).

Of course, FIG. 15 illustrates computing device 1510, display device 1520, and input device 1530 as separate devices for ease of identification only. Computing device 1510, display device 1520, and input device 1530 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 1510 may be one or more servers, for example a farm of networked servers, a clustered server environment, or a cloud network of computing devices.

While systems and methods are described herein by way of example and embodiments, those skilled in the art recognize that the disclosed embodiment is not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A computer-implemented method executed by one or more computing devices for connecting real-world vendors with customers through a virtual interface, the method comprising:
receiving, by at least one of the one or more computer devices, through a virtual interface, information from a user regarding a desired product or service;
providing, by at least one of the one or more computer devices, through the virtual interface, information to the user regarding one or more real-world vendors offering the desired product or service; and
enabling, by at least one of the one or more computer devices, interactions between the user and at least one of the one or more vendors offering the desired product or service through the virtual interface.

2. An apparatus for connecting real-world vendors with customers through a virtual interface, the apparatus comprising:
one or more processors; and
one or more memories operatively coupled to at least one of the one or more processors and having instructions stored thereon that, when executed by at least one of the one or more processors, cause at least one of the one or more processors to:
receive, through a virtual interface, information from a user regarding a desired product or service;
provide, through the virtual interface, information to the user regarding one or more real-world vendors offering the desired product or service; and
enable, interactions between the user and at least one of the one or more vendors offering the desired product or service through the virtual interface.

3. At least one non-transitory computer-readable medium storing computer-readable instructions that, when executed by one or more computing devices, cause at least one of the one or more computing devices to:
receive, through a virtual interface, information from a user regarding a desired product or service;
provide, through the virtual interface, information to the user regarding one or more real-world vendors offering the desired product or service; and
enable interactions between the user and at least one of the one or more vendors offering the desired product or service through the virtual interface.
